(19) United States
(12) Patent Application Publication
(10) Pub. No.: US 2019/0080389 A1
(43) Pub. Date: Mar. 14, 2019

(54) Method for Creating and Dressing an Avatar for Online Garment Shopping

(71) Applicant: Sam Ottaifa, Oneida, NY (US)

(72) Inventor: Sam Ottaifa, Oneida, NY (US)

(21) Appl. No.: 15/700,178

(22) Filed: Sep. 11, 2017

(51) Int. Cl. G06Q 30/06; G06T 19/20; G06K 9/00

(52) U.S. Cl. CPC G06Q 30/0643; G06Q 30/0633; G06T 2200/24; G06K 9/00664; G06T 2219/2004; G06T 19/20

(57) ABSTRACT

A method and system on an online web page or mobile application for buying and selling wearable items whereby the buyer can create an avatar of a person by uploading a photograph of the person onto the webpage or mobile application and the avatar can be dressed in wearable items selected by the user from a list of a plurality of suppliers. Additional wearable items can be selected by the user and dressed on the avatar on combination with items previously selected. The user can then purchase any of the selected items.

### BACKGROUND OF THE INVENTION

The explosion of the internet and mobile applications have permanently altered how consumers and retailers connect for commerce. E-commerce is an American staple, and yet there remain limitations and challenges in the virtual shopping experience where improvements are needed. Clothing retailers, for example, are still faced with the problem of providing the correct fit for a selected garment, with item returns accounting for a significant portion of E-commerce related expenses. Furthermore, even if the consumer selects the proper size garment, in many cases people do not pair garment from a single supplier when dressing. There currently exists a need for a mobile application where a user can shop for and try on garments or other wearable items from a plurality of suppliers and dress them together, if the they choose, on a single virtual representation of the user or another person if not shopping for them self.

The present invention relates to a system and method for utilizing spatial configuration to allow a user to create a 360-degree dimensional avatar and try on and purchase wearable items from an unlimited number of suppliers through a single mobile application while allowing multiple suppliers to offer wearable products through a single unified mobile online platform. Currently spatial configuration alteration is established in the art. The present invention combines the use of spatial configuration alteration and online shopping to create a virtual dressing room where consumers and clothing companies can come together without many of the current limitations. A user of the present invention can select a pair of shoes from one supplier and a pair of blue jeans from another, with a shirt from yet another supplier and virtually try on all three items at the same time.

### BRIEF SUMMARY OF THE INVENTION

The present invention in the preferred embodiment consists of a method and system utilizing an online mobile application on the Internet, whereby a user can view a plurality of wearable items for a plurality of suppliers with the option to view or purchase the items. The wearable items are displayed on an avatar, using spatial configuration, to allow the user to approximate how the wearable items will look when worn. The avatar is a 360-degree dimensional avatar, allowing the user to view the avatar in three dimensions from any point of view on a mobile device. The 360-degree dimensional avatar is created by utilizing at least one photograph of a person, the target subject, that is uploaded to the application through the mobile device. Software is then used to create the 360-degree dimensional avatar of the target subject in the photograph that depicts the dimension of the target subject in 360 degrees. The software determines the Spatial configuration of the target subject and uses this data to alter the spatial configuration of the selected wearable items to over-lay the virtual images of the wearable items to “dress” the avatar and create the virtual representation of how the person will look when wearing the item or items “dressed” on the avatar.

The mobile application provides a list of suppliers of garments and wearable items and accessories. The user selects a supplier and then a subsequent item from said supplier, whereby the software alters the spatial configuration of the item and creates a three-dimensional depiction of the item that can be dressed on the 360-degree dimensional avatar of the target subject. Selected items can be interchanged by selecting a replacement item, such as a different pair of shoes, which is then dressed on the 360-degree dimensional avatar replacing the original pair of shoes that is deleted from the 360-degree dimensional avatar.

In one embodiment of the present invention, the user has the option of entering details of the target subject, such as skin tone and known garment sizes including chest, waste, bust, inseam, and shoe size. The mobile application supplies a menu whereby the user can enter said information that is incorporated into the spatial configuration determination by the software in creating the 360-degree dimensional avatar.

In one embodiment of the present invention, the mobile application software is linked to the online store of the plurality of retail suppliers. The user can select a garment or other wearable item from the menu of the retailer's store and the photo of the selected item is used as base data whereby the spatial configuration of the item is altered to match that of the 360-degree dimensional avatar of the target subject enabling the item to be dressed on the 360-degree dimensional avatar of the target subject.

### BRIEF DESCRIPTION OF THE DRAWINGS

FIG. 1 represents the method, in a flow-chart format, depicting the steps for application. The initial steps allow for creating the 360-degree dimensional avatar from a photograph of a target subject. The user can select a supplier of wearable items and then select wearable items from a list offered by the selected supplier. The next steps allow for “dressing” the avatar using spatial configuration to over-lay virtual images of wearable items over the 360-degree dimensional avatar. These steps are repeatable as different wearable items can be dressed on the 360-degree dimensional avatar simultaneously to depict how the person will look while wearing the items selected and dressed on the 360-degree dimensional avatar. Finally, the last steps allow the user to purchase any item selected from the list of items offered by the supplier selected from the list of suppliers.

### DETAILED DESCRIPTION OF THE INVENTION

The present invention, in the preferred embodiment, is a method and system implemented as an online mobile application accessed on the Internet for purchasing wearable items from a plurality of retail suppliers. The mobile application being implemented on the user's mobile device serves as a purchasing portal operating via Application Programming Interfacing (API), and affiliate program participation. In the preferred embodiment of the present invention, the mobile application comprises three primary components, namely: the mobile application software, the mobile application backend, and the backend server. The mobile application software enables the user to input data is the sole display on the cooperably paired mobile device. The application backend serves to send data to the mobile application software and connects the user with the online retailer's stores. The server stores all the data, including account information, and processes payment transactions. A diagrammatic flowchart depiction of the mobile application backend directs the reader. The application API connects the mobile application to the server and other components of the system. The backend is responsible for file and data storage, e-commerce transactions and the image identification and personalization processes. The image recognition and composite image generation performed by the mobile application software are preferably preformed on the server to account for the limited processing capabilities of mobile devices and to minimize the digital footprint of the application on the memory of the mobile communication device.

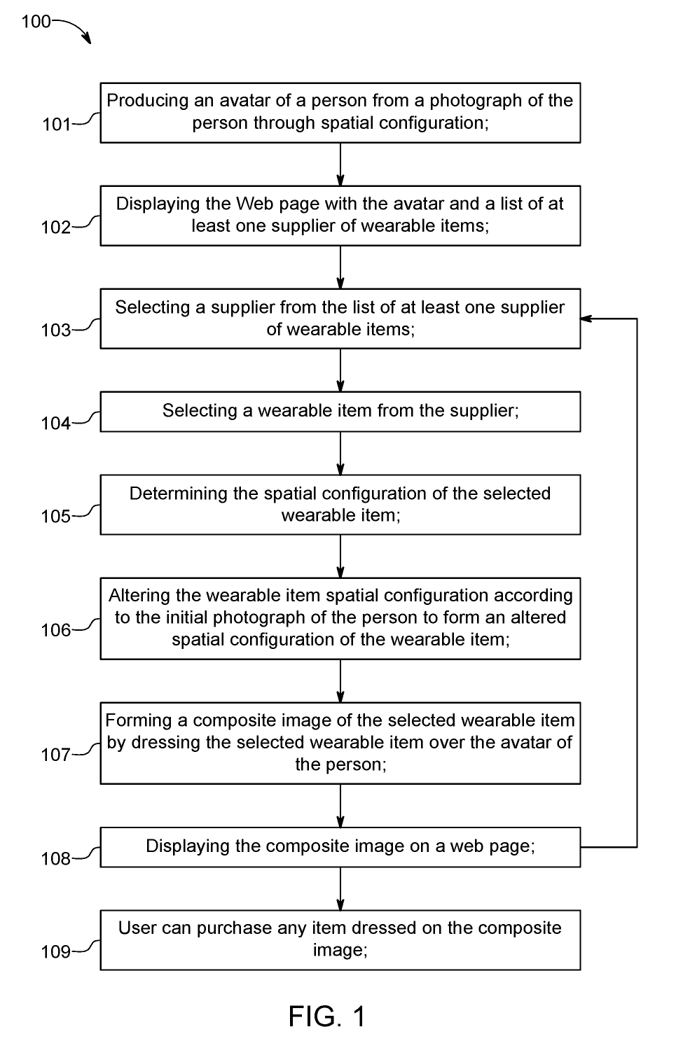

To utilize the mobile application, Step 1, shown in FIG. 1 as 101, consists of a user uploading a photograph of a person, the target subject. The photograph of the target subject is then transferred to the server, whereby the application software creates a 360-degree dimensional avatar of the person in the photograph through spatial configuration alteration. Specifically, the image creation process begins with image recognition to determine the spatial configuration of the target subject. In one embodiment of the present invention, a plurality of photographs are required to be uploaded to increase the number of data points to determine the spatial configuration of the 360-degree dimensional avatar. Additional data points are gained from the user supplying information regarding the size, shape and skin tone of the target subject by creating a user profile on the mobile application for each target subject. Said data is then used to modify a standard avatar template of a 360-degreee dimensional avatar by altering the spatial configuration to match that of the target subject. The same modification process is utilized for modifying the spatial configuration of the wearable items prior to overlaying them on the 360-degreee dimensional avatar to effectuate “dressing” the avatar in the selected wearable item.

Step 2, shown in FIG. 1 as 102, allows the user to view the 360-degree dimensional avatar and a list of at least one supplier of wearable items. This supplier can be any company that offers for sale a wearable item. The items can be any wearable items including but not limited to clothing, shoes, accessories and headwear. Step 3, shown in Figure as 103, allows the user to select a supplier from the list of at least one supplier. Step 4, shown in FIG. 1 as 104, allows the user to select a wearable item from the list of wearable items offered for sale by the selected supplier. Step 5, shown in FIG. 1 as 105, uses the mobile application software to determine the spatial configuration of the selected wearable item. Step 6, shown in FIG. 1 as 106, uses the software to alter the spatial configuration of the selected wearable item to match the virtual dimensions of the target subject, previously uploaded in step 1, in order to configure the selected wearable item to match the dimensions of the 360-degree dimensional avatar created in step 1. Step 6, shown in FIG. 1 as 106, uses the mobile application software to form a composite image by “dressing” the 360-degree dimensional avatar to depict the avatar as wearing the selected wearable item from step 4. Step 7, shown in FIG. 1 as 107, displays the composite image on the web page or mobile application. This web page can be on a computer, mobile device, or any device capable of viewing webpages on the Internet. The web page can also be displayed on a device as a stand-alone application on a mobile device as sold in the Apple App Store or comparable entities for Android devices or other future similar entities not yet in existence. The final step 8, shown in FIG. 1 as 108, allows the user to purchase any item selected in step 3 and dressed on the composite image of the avatar. Following step 7, the user has the option of returning to step 3, whereby the user can select another wearable item and add that additional item to the composite item along with the initially selected item. If the item selected replaces an item currently dressed on the 360-degree dimensional avatar, the software deleted the current item in favor of adding the second selected item.

In one embodiment of the present invention, the user will view the existing online retail store for the supplier and select an item from the list of items presented on said online retail store. For example, if the supplier was Macys.com, the mobile application software would link to the Macys.com website and allow the user to view the items available from Macys.com on the mobile communications device. Once an item was selected, the mobile application software would perform image recognition and spatial configuration modification to alter the image of the wearable item to match the 360-degree dimensional avatar of the target subject to then dress the avatar and display how the target subject would appear while wearing the item selected from Macys.com. Presumably this example could work with any online retail store.

By allowing the user to dress a plurality of wearable items on the same avatar, the user can view the avatar with any combination of wearable items offered by any of the suppliers in the list. The user can view the avatar and select any of the selected wearable items for purchase. Items saved on the user's rack will be placed in a sub-view of the rack for access.

The user has continued access to profile data and can update and change aspects of the profile at any time. Additionally, the user can create multiple 360-degree dimensional avatars for multiple target subjects as desired. In the preferred embodiment, the mobile application is presented as a single feed view with several supporting screens whereby the user can save additional information on the user profile including bookmarking favorite retailers and details regarding items. Following the initial setup, the user has the option to connect social friends via social networking sites and applications.

We claim:

1. A computer-based mobile application implemented on a cooperably associated mobile communication device for enabling a user to virtually view the appearance of at least one wearable item, selected from a list of suppliers of wearable items, dressed on a 360-degree dimensional avatar of a target subject displayed upon the mobile communication device, comprising:
(A) producing a 360-degree dimensional avatar of the target subject from a photograph of the target subject through spatial configuration recognition and image production software;
(B) displaying the 360-degree dimensional avatar and a list of at least one supplier of wearable items;
(C) selecting a supplier of wearable items from the list of at least one supplier of wearable items;
(D) displaying a list of wearable items from the selected supplier of wearable items;
(E) selecting a wearable item from the list of wearable items;
(F) determining the spatial configuration of the wearable item;
(G) altering the spatial configuration of the wearable item according to the virtual dimensions of the 360-degree dimensional avatar;
(H) forming a composite image by dressing the wearable item over the 360-degree dimensional avatar; and
(I) displaying the composite image on the mobile communication device.

2. The method of claim 1, whereby the spatial configuration recognition and image production software comprises:
(A) image recognition means for recognizing and retrieving a plurality of spatial configuration data from the photograph of the target subject and a photograph of the wearable items selected by the user in step E of claim 1;
(B) image modification means for altering a standard avatar template upon applying the retrieved spatial configuration data to create the 360-degree dimensional avatar in the likeness of the target subject;
(C) image modification means for altering the spatial configuration of the photograph of the wearable item to match that of the 360-degree dimensional avatar;
(D) composite image overlay means for dressing the 360-degree dimensional avatar by applying image overlay of the altered photograph of the wearable item; and
(E) mobile communication device image display means for visually displaying the composite image of the 360-degree dimensional avatar on the cooperably associated mobile communication device.

3. The method of claim 2, further comprising repeating steps C through I from claim 1, whereby the additionally selected wearable item is dressing over the existing composition image of the 360-degree dimensional avatar produced in step H from claim 1.

4. A system for a computer-based mobile application implemented on a cooperably associated mobile communication device for enabling a user to virtually view the appearance of at least one wearable item, selected from a list of suppliers of wearable items, dressed on a 360-degree dimensional avatar of a target subject displayed upon the mobile communication device, comprising:
(A) a mobile communications device comprising a visual display and software implementation means;
(B) a server for storing data and processing financial transactions in e-commerce; and
(B) a mobile application software comprising:
(i) image recognition means for recognizing and retrieving a plurality of spatial configuration data from the photograph of the target subject and a photograph of the wearable items selected by the user in step E of claim 1;
(ii) image modification means for altering a standard avatar template upon applying the retrieved spatial configuration data to create the 360-degree dimensional avatar in the likeness of the target subject;
(iii) image modification means for altering the spatial configuration of the photograph of the wearable item to match that of the 360-degree dimensional avatar;
(iv) composite image overlay means for dressing the 360-degree dimensional avatar by applying image overlay of the altered photograph of the wearable item; and
(v) mobile communication device image display means for visually displaying the composite image of the 360-degree dimensional avatar on the cooperably associated mobile communication device.
